(19) United States
(12) Patent Application Publication
(10) Pub. No.: US 2024/0279537 A1
(43) Pub. Date: Aug. 22, 2024

(54) OPTICALLY RESPONSIVE FULL COLOR SHIFTING COLLOIDAL LIQUID

(71) Applicant: The University of Hong Kong, Hong Kong (CN)

(72) Inventors: Jinyao TANG, Hong Kong (CN); Jing ZHENG, Hong Kong (CN)

(73) Assignee: The University of Hong Kong, Hong Kong (CN)

(21) Appl. No.: 18/573,569

(22) PCT Filed: Jun. 9, 2022
(86) PCT No.: PCT/CN2022/097814

§ 371 Date: Dec. 22, 2023

Related U.S. Application Data
(60) Provisional application No. 63/213,987, filed on Jun. 23, 2021.

(51) Int. Cl. C09K 9/02; C01G 23/047

(52) U.S. Cl. CPC C09K 9/02; C01G 23/047; C09K 2211/183

(57) ABSTRACT

A chromic liquid capable of responding to and reproducing external optical color illumination is formed as a TiO₂ colloid imbued with three sensitizing dyes. The dyes are (a) SQ2 (5-carboxy-2-[[3-[(2,3-dihydro-1,1-dimethyl-3-ethyl-1H-benzo[e]indol-2-ylidene)methyl]-2-hydroxy-4-oxo-2-cyclobuten-1-ylidene]methyl]-3,3-dimethyl-1-octyl-3H-indolium), (b) LEG4 (3-{6-{4-[bis(2′,4′-dibutyloxybiphenyl-4-yl)amino-]phenyl}-4,4-dihexyl-cyclopenta-[2,1-b:3,4-b′]dithiophene-2-yl}-2-cyanoacrylic acid) and (c) L0 (4-(diphenylamino) phenylcyanoacrylic acid). The liquid reproduces cyan, magenta and yellow color or a mixture thereof in response to exposure to illumination by light of various colors.

This international patent application claims the benefit of U.S. Provisional Patent Application No. 63/213,987 filed on Jun. 23, 2021, the entire content of which is incorporated by reference for all purpose.

### FIELD OF THE INVENTION

The present invention relates to photochromic materials that perform similar to electronic ink and, more particularly, to a dye material that changes color in response to incident light without the application of an electric field.

### BACKGROUND OF THE INVENTION

In nature, many species evolved with the ability to change color to blend into the environment. This ability is highly desired for many novel applications, such as electronic ink, smart windows, and military camouflage. Currently, the existing technology does not provide such materials, or the cost prevents wide application

Inspired by natural metachromatism, the design and fabrication of chromic materials and devices has motivated substantial research efforts over the past decades due to their promise for a future in camouflage, sensors, color displays, smart windows, etc. [1], [2], [3], [4], [5] To date, many chromic materials have been developed to realize metachromatism such as electrochromic materials [6], [7], [8], thermochromic materials [9], [10], [11], photochromic materials [12], [13], [14], and plasmonic materials [15], [16], [17]. Each approach has its own comparative advantages and favorable conditions, such as appreciable scalability of optical responses, reversible color reproduction, ink-free system, excellent stability, etc. However, most approaches are inherently limited to static optical characteristics, such as fixed shape, restricted color gamut and sluggish response. Also, most current photochromic materials are limited to showing a single color. The current electronic ink (e-ink) technology also only provides a single color display ability, with the full color e-ink achieved by combining traditional black-white e-ink with three color masks, which is intrinsically limited with low color reproduction ability. Moreover, the various forms of current technology all require external electrical power input, which reduced their reliability.

Dye-sensitization is a well-known technique for solar cell application. It causes the cell to absorb visible light.

Information about a dye-sensitized TiO₂ colloid for a nanorobot was published by the present inventors a few years ago. (Nat. Commun. 8, (1), 1438. (2017))

The realization of flexible dynamic optical color characteristics, with multiple rapid responses to external optical stimuli without electrical input would be especially beneficial in this area of technology.

### SUMMARY OF THE INVENTION

The present invention relates to a new class of photochromic liquid materials, which goes much beyond ink. Particularly, it is not an e-ink, i.e., a brand of electronic paper (e-paper) display technology, since no electrical input or electric bias is applied to the solution. Although it can perform many functions similar to e-ink, it does not require a conductive coating as does e-ink, which greatly reduces its cost.

This invention is a programmable, full-color colloidal liquid, e.g., an ink, capable of responding to and reproducing external optical information based on the subtractive color model. The invention was inspired by the CMYK color model and uses three kinds of dyes (cyan, magenta and yellow dye) selected to sensitize TiO₂ colloids so as to not only offer three basic colors (cyan, magenta and yellow), but to encode them with a decoupled spectrum response, i.e. each color response is independent of the other. The colloids, after illumination reproduce the input illumination. By leveraging the separated color absorption spectra of the colloid, it is feasible for both triple-channel control and the adjustment of the proportions of the colored outputs of the colloid, thus yielding a wide color gamut.

With a properly designed redox shuttle system, this colloid responds to light by generating a self-propulsion force that causes rearrangement of the internal structure of the colloidal solution. In particular, the input light causes a relatively rapid vertical stratification of the colloid. Due to the different spectral response of the layers of the colloid, the altered internal arrangement of the colloidal solution due to external illumination, gives the solution different apparent color outputs.

Since the absorption spectrum falls in the visible light domain, a modified commercial 3LCD projector can be utilized as a signal generator, which offers a flexible programmable stimulus of color, light intensity and optical pattern. Moreover, since the color texture presented by the colored colloids is mainly caused by the vertical stratification of different color colloids, only a short period of exposure time is required and the resulting texture has a fast response and remains relatively stable after removing the light source.

Further, from a commercial and mass production perspective, the simplicity of preparation and the ready availability of raw materials offers great potentialities for this tricolor ink. With its rather simple preparation process, this color-shifting liquid can be mass produced with low fabrication cost. After formulation, this new ink can be produced as a color-shifting paint which can be applied on a variety of surfaces in order to make use of its color-shifting ability. This system is completely self-sustained. No external power, no electrode and no active-matrix are needed to show a pattern. Thus, this system holds promise as optical camouflage in military applications, smart-windows for building thermal management, and full-color electronic ink for e-readers.

Also, since the TiO₂ colloid is light-sensitive, which means it reacts upon illumination by a corresponding light source, it can be used as any color adaptive material including as e-ink.

The new structure is formed as dye-sensitized TiO₂ colloids, which differs from other structures. For example, a solar cell must have two conductive electrodes for electric current flow in and out. With the present invention no such conductor structures are needed. Instead with the present invention a dye-sensitized TiO₂ colloid is used for a photochromic application.

The dye used in this invention is a photostable dye made for solar cell application, while in principle, all other commercial dyes can also be used.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

The foregoing and other objects and advantages of the present invention will become more apparent when considered in connection with the following detailed description and appended drawings in which like designations denote like elements in the various views, and wherein:

FIG. 1A shows a typical CMYK color mode system, FIG. 1B is a photograph of SQ2, LEG4 and L0 loaded TiO₂ colloids and their mixed suspension, which perform as cyan, magenta, yellow and black ink, respectively, FIG. 1C is a photograph of SQ2, LEG4 and L0 loaded TiO₂ colloids, FIG. 1D illustrates a reversible assembly of colored colloids under switched illumination of complementary light, FIG. 1E shows a mixture of the tricolor colloids transferred into a transparent chamber where different light illumination induces vertical stratification of different dyed colloids and the formation of a visible pattern;

FIG. 2A shows the wavelength-dependent effective potential w(r) as a function of r/a for LEG4 sensitized TiO₂, where the insert shows the normalized absorbance of LEG4 sensitized TiO₂ in a solar cell, FIG. 2B shows the wavelength-dependent effective potential w(r) as a function of r/a for SQ2 sensitized TiO₂ and the insert shows the normalized absorbance of SQ2 sensitized TiO₂ in a solar cell. FIG. 2C shows the effective potential for SQ2-SQ2 sensitized TiO₂ under red light (650 nm) at intensities of 1 mW/cm², 5 mW/cm², 10 mW/cm² and 20 mW/cm², FIG. 2D shows the effective potential for LEG4-LEG4 sensitized TiO₂ under red light (650 nm) at intensities of 1 mW/cm², 5 mW/cm², 10 mW/cm² and 20 mW/cm², FIG. 2E shows the effective potential for LEG4-SQ2 under red light (650 nm) at intensities of 1 mW/cm², 5 mW/cm², 10 mW/cm² and 20 mW/cm², FIG. 2F shows the effective potential for SQ2-SQ2 sensitized TiO₂ under blue light (480 nm) at intensities of 1 mW/cm², 5 mW/cm², 10 mW/cm² and 20 mW/cm², FIG. 2G shows the effective potential for LEG4-LEG4 sensitized TiO₂ under blue light (480 nm) at intensities of 1 mW/cm², 5 mW/cm², 10 mW/cm² and 20 mW/cm² and FIG. 2H shows the effective potential for LEG4-SQ2 under blue light (480 nm) at intensities of 1 mW/cm², 5 mW/cm², 10 mW/cm², and 20 mW/cm²;

FIG. 3A shows a 3D separation schematic of tricolor ink under an optical microscope with blue light illumination, FIGS. 3B-3D show 3D distributions of colored colloids at several depth (Z=0, 20, 40, 60, 80 m) under blue, green and red light illumination, respectively, and FIGS. 3E-3G show 3D distributions of color colloids recorded by a confocal microscope;

FIG. 4A shows a modified projector with added optical filters, FIG. 4B shows the normalized spectrum of the projector output for blue, green and red light with an optical filter (solid line) or without an optical filter (dash line), FIG. 4C shows six color patterns containing red, green, blue, cyan, magenta and yellow as an illumination source, FIG. 4D shows the macroscopic image of color patterns formed in the colloid of the present invention under the illumination light pattern in FIG. 4C; FIG. 4E shows the corresponding reflective spectra from the color plates in FIG. 4D and FIG. 4F shows an experimental color gamut presented in a standard CIE-1931 color space; and

FIG. 5A shows an image of Van Gogh's self-portrait as an optical illumination pattern, FIG. 5B shows the macroscopic image of color texture under optical pattern illumination of FIG. 5A, for 2 minutes. FIGS. 5C-5G are a sequence of images showing the stability of the light painting of Van Gogh's self-portrait for periods of 5 min, 10 min, 15 min, 20 min and 30 min, respectively, and FIG. 5H shows the back side of the complementary colors of the image of FIG. 5B.

### DETAILED DESCRIPTION OF THE INVENTION

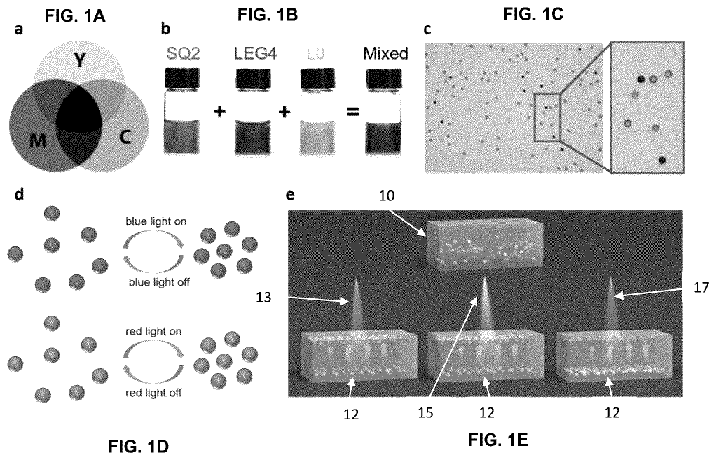

The present invention is a full-color material in the form of a colloidal liquid containing three colored dyes selected to sensitize TiO₂ colloids. The tricolor colloid is capable of responding to and reproducing external optical information based on the subtractive color model. The invention, inspired by the CMYK color model (FIG. 1A), uses cyan, magenta and yellow color dyes. The preferred sensitizing dyes (a) SQ2 (5-carboxy-2-[[3-[(2,3-dihydro-1,1-dimethyl-3-ethyl-1H-benzo[e]indol-2-ylidene)methyl]-2-hydroxy-4-oxo-2-cyclobuten-1-ylidene]methyl]-3,3-dimethyl-1-octyl-3H-indolium), (b) LEG4 (3-{6-{4-[bis(2′,4′-dibutyloxybiphenyl-4-yl)amino-]phenyl}-4,4-dihexyl-cyclopenta-[2,1-b:3,4-b′]dithiophene-2-yl}-2-cyanoacrylic acid) and (c) L0 (4-(diphenylamino) phenylcyanoacrylic acid), are employed to tincture (imbue) TiO₂ colloid with cyan, magenta and yellow color, respectively. FIG. 1B is a photograph of SQ2, LEG4 and L0 loaded TiO₂ colloids and their mixed suspension, which perform as cyan, magenta, yellow and black ink, respectively, in the system. FIG. 1C is a photograph of SQ2, LEG4 and L0 loaded TiO₂ colloids. Besides, providing separated absorption peaks, these three dyes also offer distinct color channels. Similar to other active colloids, the dye-sensitized TiO₂ colloids can exhibit light-induced swarming and assembling. [18], [19], [20]. These orthogonal swarms and the assemblies they produce are largely reversible due to the discrete absorption spectrum. As shown in FIG. 1D, the red colloids form aggregates (on the right) upon blue light illumination and spread out (on the left) once the light is switched off. Likewise, blue colloids assemble under red light and vice versa. When a certain type of colloids aggregate, they collectively generate a force that pushes other types of colloids vertically upward. In particular, different light illumination induces vertical stratification of different dyed colloids and the formation of a visible pattern. As shown in FIG. 1E, a mixture of the tricolor colloids 10 is transferred into transparent chambers 12 and a specific color will show up in each chamber due to the light-induced stratification under the correlated light illumination 13, 15, 17.

The light-induced interactions among dye-sensitized colloids respond differently to various light intensity and wavelength, wherein the attraction and repulsion can be characterized by a radial distribution function g(r) and an effective potential of mean force w(r). For a specific two components system (such as LEG4 and SQ2 sensitized TiO₂ colloids), the radial distribution function can be calculated from scores of statistical location information, according to the general expression Eq. (1) See [21], [22], [23].

$$g ( r ) = \frac{N ( r ) A}{{N}^{2} π rdr} \qquad ( 1 )$$

where r is a separation distance, N(r) is the number of colloidal pairs at separation distance r and N is the total number of colloids in each image, A is the viewed area with 1920×1080 pixels. The Eq. (2) is derived to calculate the radial distribution function between species α and β, where the number of them is denoted as N_{α} and N_{β}, respectively.

$${g}_{αβ} ( r ) = \frac{A}{{N}_{α} {N}_{β}} 〈 {\sum }_{i = 1}^{{N}_{α}} {\sum }_{j = 1}^{{N}_{β}} δ ( r - ( {r}_{i} - {r}_{j} ) ) 〉 \qquad ( 2 )$$

With finite concentration, the radial distribution function can reflect the interaction between neighboring colloids. Generally, the effective potential of the mean force can be determined by Eq. (3):

$$w ( r ) = - {k}_{B} T ln g ( r ) \qquad ( 3 )$$

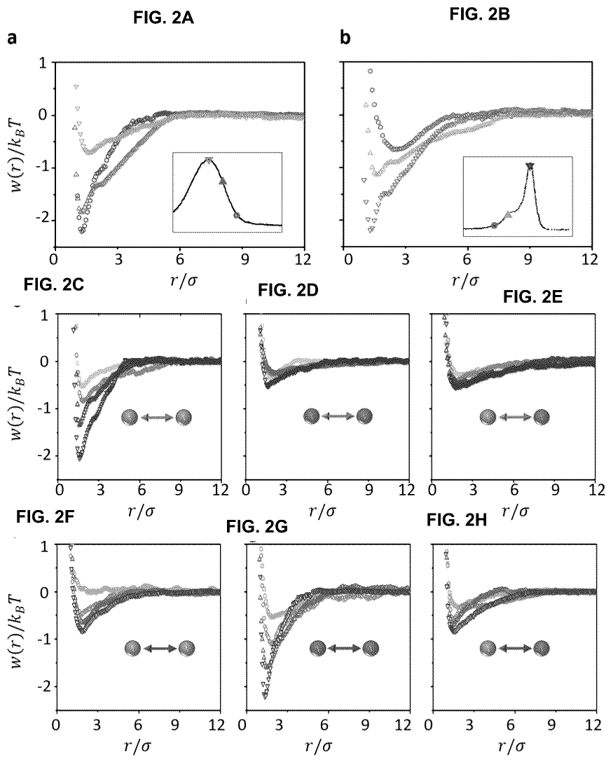

Experimentally, the tricolor ink was observed under an Olympus BX51M optical microscope, and was recorded by a digital video camera (Canon EOS M50) at 1920×1080 resolution. A super-continuum laser (SC-Pro, Wuhan Yangtze Soton Laser Co., Ltd.) coupled with a variable linear filter was used as the light source. To determine the specific effective potential of different dyed colloids, several characteristic wavelengths were selected. FIG. 2 shows the wavelength dependent effective potential w(r) as a function of r/σ. The effective potentials of LEG4 (FIG. 2A) and SQ2 (FIG. 2B) for sensitized TiO₂ colloids enhanced with the incremental light response were plotted. The inserts in FIGS. 2A and 2B show the normalized absorbance of LEG4 and SQ2 sensitized TiO₂ in a solar cell. Under red light (650 nm) at intensities of 1 mW/cm², 5 mW/cm², 10 mW/cm² and 20 mW/cm², respectively, the potential between SQ2 sensitized colloids (w_{SQ2-SQ2}(r), FIG. 2C) was lower than the potential between LEG4 sensitized colloids (w_{LEG4-LEG4}(r), FIG. 2D) and their cross potential (w_{LEG4-SQ2}(r), FIG. 2E). The SQ2 and LEG4 sensitized colloids work as active and passive particles, respectively, resulting in heterogeneous clusters. Whereas under blue light illumination (480 nm) at intensities of 1 mW/cm², 5 mW/cm², 10 mW/cm², 20 mW/cm², respectively, the w_{LEG4-LEG4}(r) (FIG. 2G) is lower than w_{SQ2-SQ2}(r) (FIG. 2F) and w_{LEG4-SQ2}(r) (FIG. 2H), occurring during the transition between active and passive states. Thus, the dyed colloids produce different aggregation states under the stimulus of different light, yielding a macroscopic color separation.

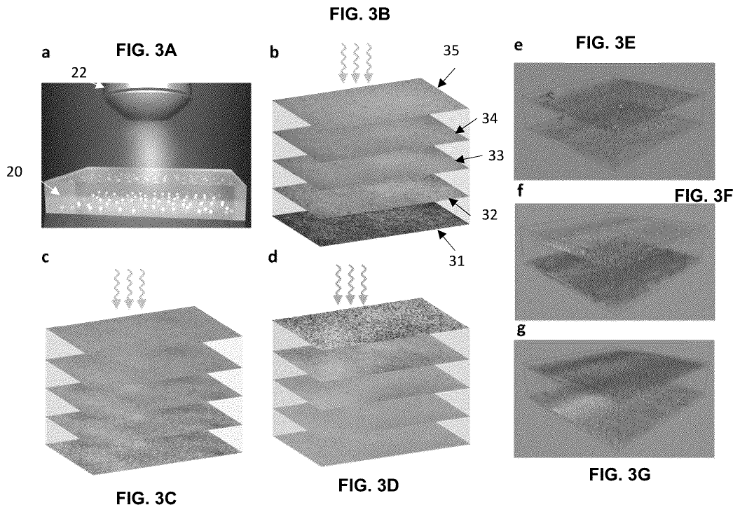

In order verify the vertical stratification of colored colloids under light illumination, a series of microscopic images at various depth were taken. Specifically, as shown in FIG. 3A the tricolor ink containing SQ2, LEG4 and L0 loaded TiO₂ colloids with a QH₂ solution as the medium was transferred to a transparent chamber 20 and observed under a microscope 22 at several depths (Z=0, 20, 40, 60, 80 μm). The filmed area of the chamber was then irradiated by blue, green and red light, respectively as shown in FIGS. 3B-3D. As shown in FIG. 3B, under blue light illumination, the active L0 and LEG4 loaded TiO₂ colloids aggregated at the bottom, layer 31 at 0 μm, while passive SQ2 loaded TiO₂ colloids were pushed up to layer 32 or above, changing the appearance of the surface layer 35 (Z=80) into cyan color. Similarly, under green and red light illumination, the active/passive couple switched to LEG4/(SQ2+L0) (FIG. 3C) and SQ2/(L0+LEG4) (FIG. 3D), which resulted in green and magenta color on the surface 35, respectively. In effect, the different external light stimulus causes the vertical separation of different color colloids due to various light absorbance.

The 3D distribution of color colloids in the form of vertical stratification was also demonstrated by recording 3D scanning under a confocal microscope while being illuminated by red (FIG. 3E), green (FIG. 3F) and blue (FIG. 3G) light. The fluorescence signals of SQ2, LEG4 and L0 loaded TiO₂ colloids are set as cyan, magenta and yellow, respectively.

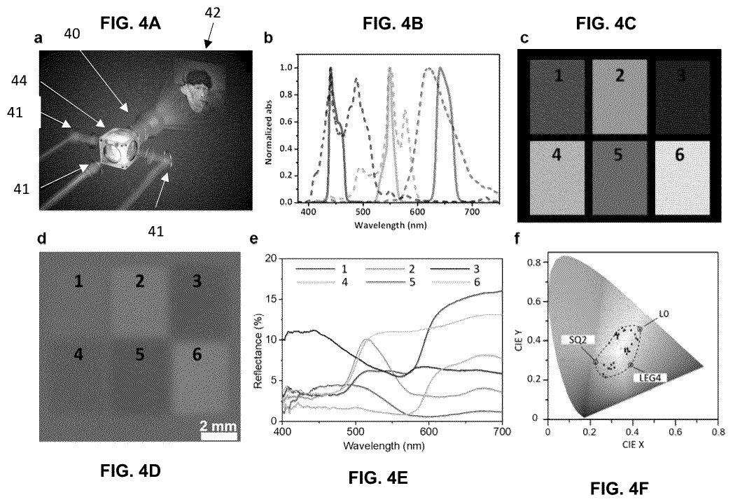

Since the absorbance of the three dye-loaded TiO₂ colloids is in the visible light domain, a regular office projector 40 can be used to provide color texture light as shown in FIG. 4A. In addition red, green and blue light is passed through three optical filters 41 respectively and pass into the container 44. The filters were added to the projector to narrow the default broader output wavelength range for non-overlapping effect (FIG. 4B). The projector can then be used to project that image onto a screen or display.

In FIG. 4B the normalized spectrum of the projector output for blue, green and red light is in solid line, which shows gaps between the wavelengths of each color. The graphs in dash line show the spectrum of the projector with the optical filters, illustrating the spread of the wavelengths so the color spectrums overlap.

To test the macroscopic display of the tricolor ink, first, six simple color textures containing red, green, blue, cyan, magenta and yellow are illuminated as stimulus signals, i.e., they are used as the illumination source (FIG. 4C). After exposure to the projector light for 2 minutes, patterns are revealed in the colloid as expected as shown in FIG. 4D, indicating a rather rapid and accurate display that holds great value in practical applications. Compare FIGS. 4C and 4D to see the reproduction results. In FIG. 4D a scale bar of 2 mm is shown. These results are characterized by reflective spectra (FIG. 4E) and color gamut in a CIE color chart, i.e., a standard CIE-1931 color space (FIG. 4F), which show a wider color gamut (than the dotted oval in FIG. 4F).

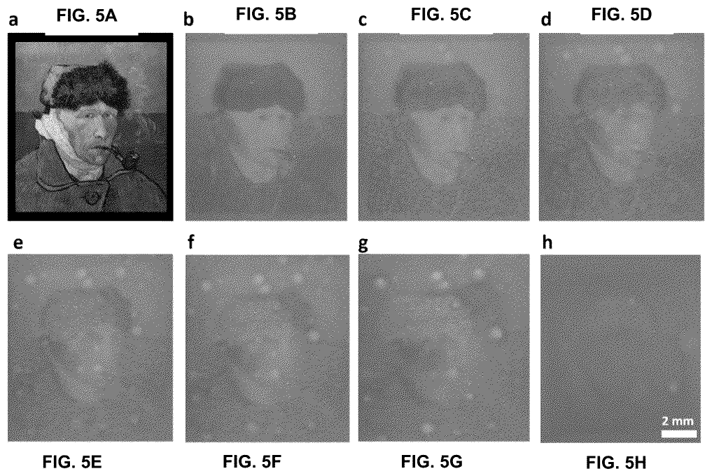

The present invention offers flexible regulation of the illuminated texture including color, shape, size and gradient. To further demonstrate the capacity of the invention to provide a complex display with a wide range of gamut, shade, saturation, and lightness over a macroscopic area, a colored image of Van Gogh's self-portrait was exploited as the incident optical pattern (FIG. 5A). With 2 minutes exposure, this colored pattern was thereafter manifested on the tricolor ink device as shown in FIG. 5B. Furthermore, the evolution of the colored texture over time showed good stability. FIGS. 5C-5G show sequential images of the light painting of Van Gogh's self-portrait for 5 min, 10 min, 15 min, 20 min and 30 min, respectively, thus showing the stability of the invention. FIG. 5H shows the back side of the light generated texture of FIG. 5B, which is complementary to the front side, echoing the up-bottom stratification. A 2 mm scale bar is shown in FIG. 5H. The demonstration of the Van Gogh's self-portrait shows remarkable reproduction and favorable stability of macroscopic complex visual images.

After formulation, this new ink can be produced as a color-shifting paint which can be applied on a variety of surfaces to realize the color-shifting ability. As this system is completely self-sustained, no external power is needed, which gives this system promise as optical camouflage in military applications, smart-windows for building thermal management, and full-color electronic ink for e-readers.

In summary, inspired by the CMYK color model, the present invention is a tricolor liquid or ink system based on dye-sensitized TiO₂ colloids with three different colors, which offers a flexible programmable painting medium or ink. Due to its rapid top-bottom stratification, it provides a quick response and color reproduction in response to external stimulus within 2 minutes. Moreover, the discrete absorption spectrum confers various colloidal couples of different colors, thus leading to a wide color gamut. Also, the simple preparation process and inexpensive ingredients offer the possibility of economy and mass production. From an application standpoint, this flexible and programmable tricolor ink system possesses great potential prospects in color-changing clothing, camouflage, display or other applications wherein flexibility, color and mobility are highly valued.

There are some limitations to the present invention in terms of the color gamut, stability and resolution. To overcome these limitation, some inorganic materials can be used to replace the organic dyes. Further, more solvents and other redox couples can be used to improve the resolution.

The cited references in this application are incorporated herein by reference in their entirety and are as follows:
[1] Reiter S, Hiilsdunk P, Woo T, Lauterbach M A, Eberle J S, Akay L A, et al. Elucidating the control and development of skin patterning in cuttlefish. Nature 2018, 562(7727): 361-366.
[2] Teyssier J, Saenko S V, van der Marel D, Milinkovitch M C. Photonic crystals cause active colour change in chameleons. Nat. Commun. 2015, 6(1): 6368.
[3] Cuthill I C, Allen W L, Arbuckle K, Caspers B, Chaplin G, Hauber M E, et al. The biology of color. Science 2017, 357(6350): eaan0221.
[4] Shawkey M D, D'Alba L. Interactions between colour-producing mechanisms and their effects on the integumentary colour palette. Philos. Trans. R. Soc. Lond., B, Biol. Sci. 2017, 372(1724):20160536.
[5] Barnett J B, Michalis C, Anderson H M, McEwen B L, Yeager J, Pruitt J N, et al. Imperfect transparency and camouflage in glass frogs. Proc. Natl. Acad. Sci. U.S.A 2020, 117(23): 12885.
[6] Gu H, Guo C, Zhang S, Bi L, Li T, Sun T, et al. Highly Efficient, Near-Infrared and Visible Light Modulated Electrochromic Devices Based on Polyoxometalates and W18O49 Nanowires. ACS Nano 2018, 12(1): 559-567.
[7] Zhang Q, Tsai C-Y, Li L-J, Liaw D-J. Colorless-to-colorful switching electrochromic polyimides with very high contrast ratio. Nat. Commun. 2019, 10(1): 1239.
[8] Kortz C, Hein A, Ciobanu M, Walder L, Oesterschulze E. Complementary hybrid electrodes for high contrast electrochromic devices with fast response. Nat. Commun. 2019, 10(1): 4874.
[9] Wang S, Xu Z, Wang T, Xiao T, Hu X-Y, Shen Y-Z, et al. Warm/cool-tone switchable thermochromic material for smart windows by orthogonally integrating properties of pillar[6]arene and ferrocene. Nat. Commun. 2018, 9(1): 1737.
[10] Lin J, Lai M, Dou L, Kley C S, Chen H, Peng F, et al. Thermochromic halide perovskite solar cells. Nat. Mater. 2018, 17(3): 261-267.
[11] Liu J-C, Liao W-Q, Li P-F, Tang Y-Y, Chen X-G, Song X-J, et al. A Molecular Thermochromic Ferroelectric. Angew. Chem. Int. Ed. 2020, 59(9): 3495-3499.
[12] Fan J, Bao B, Wang Z, Li H, Wang Y, Chen Y, et al. Flexible, switchable and wearable image storage device based on light responsive textiles. Chem. Eng. J. 2021, 404: 126488.
[13] Seeboth A, Lötzsch D, Ruhmann R, Muehling O. Thermochromic Polymers—Function by Design. Chem. Rev. 2014, 114(5): 3037-3068.
[14] Wales D J, Cao Q, Kastner K, Karjalainen E, Newton G N, Sans V. 3D-Printable Photochromic Molecular Materials for Reversible Information Storage. Adv. Mater. 2018, 30(26): 1800159.
[15] Neubrech F, Duan X, Liu N. Dynamic plasmonic color generation enabled by functional materials. Sci. Adv. 2020, 6(36): eabc2709.
[16] Duan X, Liu N. Scanning Plasmonic Color Display. ACS Nano 2018, 12(8): 8817-8823.
[17] James T D, Mulvaney P, Roberts A. The Plasmonic Pixel: Large Area, Wide Gamut Color Reproduction Using Aluminum Nanostructures. Nano Lett. 2016, 16(6): 3817-3823.
[18] Palacci J, Sacanna S, Steinberg A P, Pine D J, Chaikin P M. Living Crystals of Light-Activated Colloidal Surfers. Science 2013, 339(6122): 936.
[19] Singh D P, Choudhury U, Fischer P, Mark A G. Non-Equilibrium Assembly of Light-Activated Colloidal Mixtures. Adv. Mater. 2017, 29(32): 1701328.
[20] Zhang J, Guo J, Mou F, Guan J. Light-Controlled Swarming and Assembly of Colloidal Particles. Micromachines 2018, 9(2)(88).
[21] Pliego-Pastrana P, Carbajal-Tinoco M D. Two-Component Polypeptides Modeled with Effective Pair Potentials. J. Phys. Chem. B 2006, 110(48): 24728-24733.
[22] Behrens S H, Grier D G. Pair interaction of charged colloidal spheres near a charged wall. Physical Review E 2001, 64(5): 050401.
[23] Chen W, Tan S, Zhou Y, Ng T-K, Ford W T, Tong P. Attraction between weakly charged silica spheres at a water-air interface induced by surface-charge heterogeneity. Physical Review E 2009, 79(4): 041403.

While the present invention has been particularly shown and described with reference to preferred embodiments thereof; it will be understood by those skilled in the art that various changes in form and details may be made therein without departing from the spirit and scope of the invention, and that the embodiments are merely illustrative of the invention, which is limited only by the appended claims. In particular, the foregoing detailed description illustrates the invention by way of example and not by way of limitation. The description enables one skilled in the art to make and use the present invention, and describes several embodiments, adaptations, variations, and method of uses of the present invention.

What is claimed is:

1. A chromic liquid capable of responding to and reproducing external optical color illumination comprising a colloid imbued with at least three colored dyes selected on the basis of a color system in order to provide a full gamut of color output.

2. The chromic liquid of claim 1 wherein the dyes are selected based on the CMYK color system.

3. The chromic liquid of claim 2 wherein the dyes are organic materials.

4. The chromic liquid of claim 3 wherein the colloid is a TiO₂ colloid and the dyes are:
(a) SQ2 (5-carboxy-2-[[3-[(2,3-dihydro-1,1-dimethyl-3-ethyl-1H-benzo[e]indol-2-ylidene)methyl]-2-hydroxy-4-oxo-2-cyclobuten-1-ylidene]methyl]-3,3-dimethyl-1-octyl-3H-indolium),
(b) LEG4 (3-{6-{4-[bis(2′,4′-dibutyloxybiphenyl-4-yl)amino-]phenyl}-4,4-dihexyl-cyclopenta-[2,1-b:3,4-b′]dithiophene-2-yl}-2-cyanoacrylic acid) and
(c) L0 (4-(diphenylamino) phenylcyanoacrylic acid); and
wherein the liquid reproduces cyan, magenta and yellow color or a mixture thereof in response to exposure to illumination by light of various colors.

5. The chromic liquid of claim 4 wherein at least one dye is made of inorganic material.

6. The chromic liquid of claim 4 further comprising solvents and other redox couples.

7. A color display comprising:
a transparent container containing a colloid imbued with at least three colored dyes selected on the basis of a color system;
a first projector for projecting a color image onto the container for a fixed period of time; and
three light sources of different color which direct their light through color related spike optical filters and then into the container for a certain period of time.

8. The display of claim 7 wherein the colloid is a TiO2 colloid and the dyes are:
(a) SQ2 (5-carboxy-2-[[3-[(2,3-dihydro-1,1-dimethyl-3-ethyl-1H-benzo[e]indol-2-ylidene)methyl]-2-hydroxy-4-oxo-2-cyclobuten-1-ylidene]methyl]-3,3-dimethyl-1-octyl-3H-indolium),
(b) LEG4 (3-{6-{4-[bis(2′,4′-dibutyloxybiphenyl-4-yl)amino-]phenyl}-4,4-dihexyl-cyclopenta-[2,1-b:3,4-b′]dithiophene-2-yl}-2-cyanoacrylic acid) and
(c) L0 (4-(diphenylamino) phenylcyanoacrylic acid).
